(19) United States
(12) Patent Application Publication
(10) Pub. No.: US 2025/0230636 A1
(43) Pub. Date: Jul. 17, 2025

(54) PERIPHERY MONITORING APPARATUS FOR WORK MACHINE

(71) Applicant: SUMITOMO HEAVY INDUSTRIES, LTD., Tokyo (JP)

(72) Inventor: Taira MATSUOKA, Kanagawa (JP)

(21) Appl. No.: 19/014,727

(22) Filed: Jan. 9, 2025

(30) Foreign Application Priority Data
Jan. 11, 2024 (JP) 2024-002300

(51) Int. Cl. E02F 9/26; E02F 9/24

(52) U.S. Cl. CPC E02F 9/264; E02F 9/24

(57) ABSTRACT

A periphery monitoring apparatus for a work machine, includes a plurality of object detection devices configured to detect an object around the work machine, and a calibration part configured to perform calibration of coordinate systems of the plurality of object detection devices, wherein the calibration part is configured to sequentially execute a plurality of calibration algorithms for the calibration in ascending order of processing time duration and number of manual operations, until the calibration is completed.

### RELATED APPLICATION

Priority is claimed to Japanese Patent Application No. 2024-002300, filed Jan. 11, 2024, the entire content of which is incorporated herein by reference.

### TECHNICAL FIELD

The disclosures herein relate to periphery monitoring systems for work machines.

### BACKGROUND

Conventionally, a periphery display system and a work machine equipped with the same are known. The periphery display system described in a related art includes a controller that generates a composite image based on a composition condition and outputs it to a display device.

The controller specifies a position of a calibration marker of a predetermined shape to be used for calibration processing in a plurality of images photographed by a plurality of cameras. The controller calculates coordinates of feature points f the calibration markers in a vehicle body coordinate system for each of the plurality of images. The controller calculates coordinate differences of the feature points of the calibration markers in the plurality of images, determines whether calibration processing is necessary or not, based on the coordinate difference, and outputs the determination result to the display device.

### SUMMARY OF THE INVENTION

One aspect of the present disclosure provides A periphery monitoring apparatus for a work machine, including a plurality of object detection devices configured to detect an object around the work machine, and a calibration part configured to perform calibration of coordinate systems of the plurality of object detection devices, wherein the calibration is configured to sequentially execute a part plurality of calibration algorithms for the calibration in ascending order of processing time duration and number of manual operations, until the calibration is completed.

### BRIEF DESCRIPTION OF THE DRAWINGS

FIG. 1 is a side view of a crane as an example of a work machine;

FIG. 2 is a rear view of the crane shown in FIG. 1;

FIG. 3 is a block diagram of a device mounted on the crane shown in FIG. 1;

FIG. 4 is a block diagram illustrating details of a calibration part shown in FIG. 3;

FIG. 5 is a flow diagram illustrating an example of calibration processing by the calibration part shown in FIGS. 3 and 4;

FIG. 6 is a schematic plane view illustrating an example of object arrangement in calibration processing shown in FIG. 5;

FIG. 7 is a drawing describing an example of a first calibration algorithm shown in FIG. 5;

FIG. 8 is a drawing describing an example of a second calibration algorithm shown in FIG. 5;

FIG. 9 is a drawing describing an example of the first calibration algorithm shown in FIG. 5;

FIG. 10A is a drawing describing an example of the second calibration algorithm using a camera shown in FIG. 5;

FIG. 10B is a drawing describing an example of the second calibration algorithm using LiDAR shown in FIG. 5; and

FIG. 11 is a flow diagram illustrating a modification of the calibration process shown in FIG. 5.

### DESCRIPTION OF THE PREFERRED EMBODIMENTS

Since a work machine includes, for example, a work attachment for moving or conveying a cargo or a load, positions and attitudes of a plurality of object detection devices mounted on the work machine and detecting surrounding objects may vary. Therefore, the work machine must be calibrated to effectively combine the results of detection of the plurality of object detection devices at the work site.

In a related periphery display system described in the related art, the aforementioned calibration process increases a burden on field workers or requires an unexpectedly long time, which may reduce productivity.

The present disclosure provides a periphery monitoring apparatus for a work machine capable of improving productivity while ensuring safety of the work machine.

According to the above aspect of the present disclosure, it is possible to provide a periphery monitoring apparatus for a work machine capable of improving productivity while ensuring safety of the work machine.

In the following, embodiments of a working machine periphery monitoring apparatus according to the present disclosure will be described with reference to the drawings.

### Embodiment 1

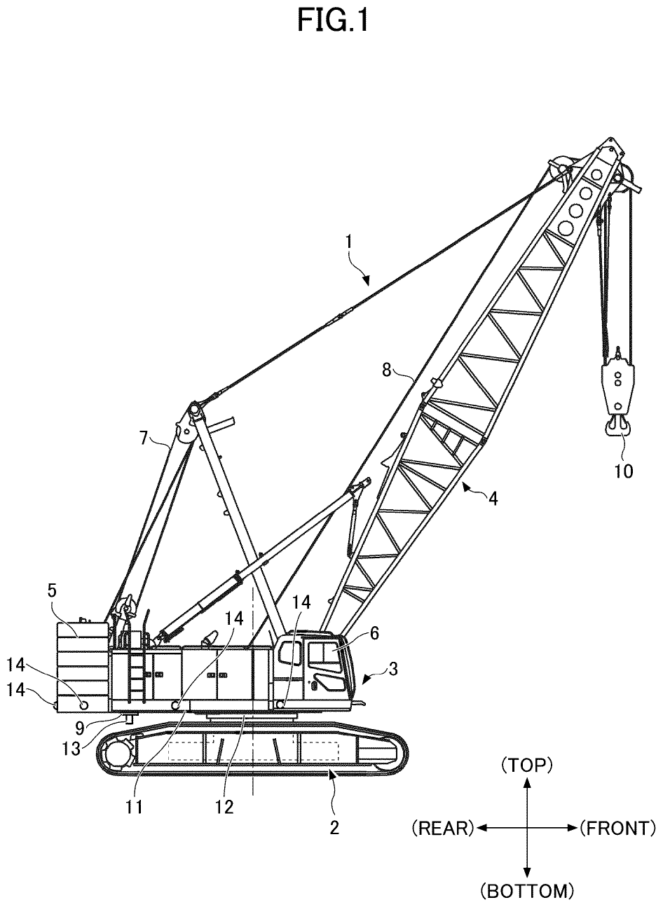

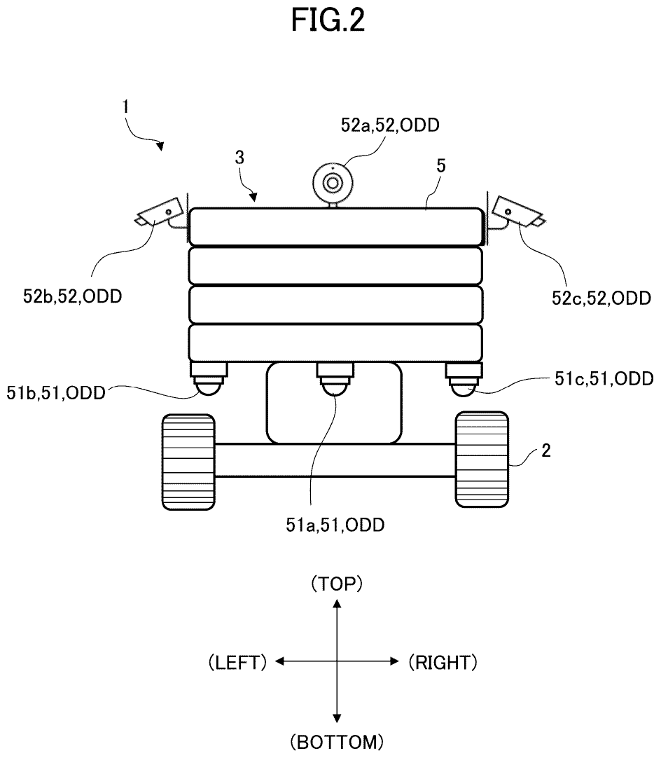

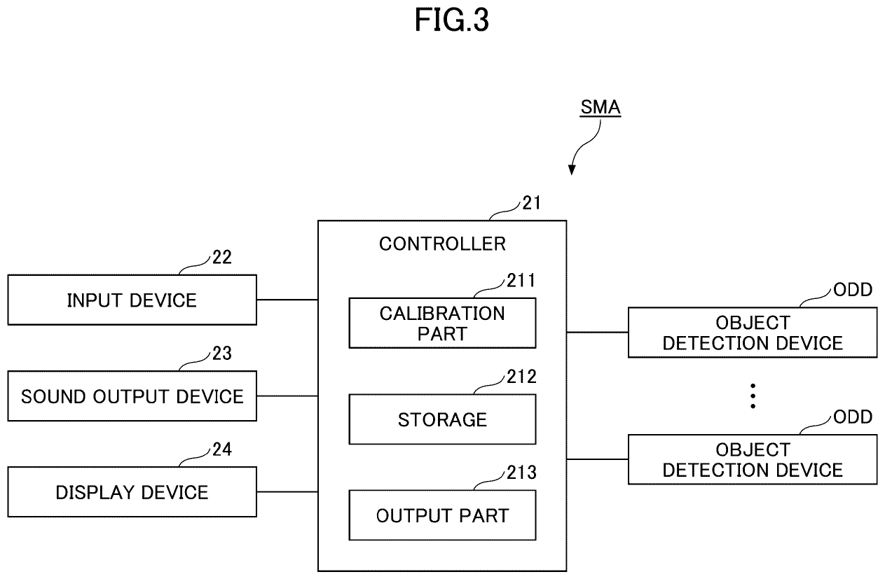

FIG. 1 is a side view of a crane 1 as an example of a work machine. FIG. 2 is a rear view of the crane 1 shown in FIG. 1. FIG. 3 is a block diagram of the device mounted on the crane 1 shown in FIG. 1.

Although details will be described later, the periphery monitoring apparatus for a work machine SMA according to the present embodiment has the following configuration as its most distinctive feature. The periphery monitoring apparatus for the work machine SMA includes a plurality of object detection devices ODD for detecting objects existing around the work machine such as the crane 1, and a calibration part 211 for calibrating the coordinate system of the object detection devices ODD. The calibration part 211 sequentially executes a plurality of calibration algorithms in an ascending order of processing time duration and a number of manual operations, until the calibration of the coordinate system of the object detection device ODD is completed.

The work machine on which the periphery monitoring apparatus SMA is mounted includes, for example, a hydraulic excavator, a road machine, a foundation construction machine, a cargo handling machine, a forklift, a wheel loader, a dump truck, etc., in addition to the crane 1. The work machine such as the crane 1 and the hydraulic excavator includes, for example, a work attachment for moving or conveying a cargo or load. The work attachment includes, for example, a jib, a wire, and rigging, or a boom, an arm, an end attachment, and a hydraulic actuator.

Hereinafter, an example of a configuration of the crane 1 as an example of a work machine will be described, and then, the periphery monitoring apparatus for the work machine SMA of the present embodiment will be described in detail.

As shown in FIG. 1, the crane 1 is what is called a mobile crawler crane. Specifically, the crane 1 includes a crawler type lower traveling body 2 capable of traveling, and an upper swivel body 3 mounted on the lower traveling body 2 capable of swiveling.

In the following description, longitudinal and lateral directions of the crane 1 as seen from an occupant will be referred to as the longitudinal and lateral directions of the crane 1. In addition, unless otherwise mentioned, the longitudinal direction of the crane 1 will be described by assuming that the lower traveling body 2 is in a state in which the longitudinal direction of the crane 1 coincides with that of the upper swivel body 3 (referred to as reference attitude) in principle. In addition, the vertical direction when the crane 1 is placed on a horizontal plane may also be referred to as the perpendicular direction.

A boom 4 is mounted on the front of the upper swivel body 3 capable of lifting. A counterweight 5 for balancing the weight of the boom 4 and a suspended load is mounted on the rear of the upper swivel body 3. A cabin 6 in which an operator is seated to control the crane 1 is arranged on the right front of the upper swivel body 3.

A lifting operation of the boom 4 is performed by winding or unwinding a wire rope (lifting rope) 7 by a lifting winch (not shown). One end of a hoisting rope 8 is connected to a hook 10 at the top end of the boom 4, and the hook 10 is suspended from the top end of the boom 4. The other end of the hoisting rope 8 is wound around a winch (not shown) on the upper swivel body 3, and the hook 10 is moved up and down by drive of the winch.

A main frame 11 located on the lower surface of the upper swivel body 3 is provided with a first measuring device mounting part 9 at a position to avoid a swivel bearing 12. A reference sensor 13 (e.g., the first LiDAR 51a, which is an omni-directional LiDAR 51 capable of measuring 360° as shown in FIG. 2) as an object detection device ODD for detecting objects around the crane 1 is fixed (e.g., fastening with screws) to the first measuring device mounting part 9. The reference sensor 13 may include one or more cameras 52 shown in FIG. 2.

The first LiDAR 51a as the reference sensor 13 can measure 360° around a sensor center axis extending vertically on the lower surface of the main frame 11. The reference sensor 13 irradiates light with a predetermined irradiation pattern at predetermined intervals while moving laser light from a space formed between the lower traveling body 2 and the upper swivel body 3 to the exterior space of the crane 1, and measures position information (three-dimensional information including a position and shape (attitude) of surrounding objects as well as a position information of a single point of the surrounding object) of surrounding objects over a wide range. The sensor center axis is a rotational axis parallel to an axis of a swivel center of the upper swivel body 3. Further, a plurality of the first measuring device mounting parts 9 may be provided.

Here, the predetermined irradiation pattern refers to a method of moving a position to be irradiated with light and a frequency of detecting the irradiated light. For example, as one pattern, the position to be irradiated with light is moved vertically to the upper end of the measuring range, and when the position is moved to the upper end of the measuring range, the position is moved horizontally by a predetermined distance, and the position is moved to the lower end of the measuring range repeatedly (irradiation is zigzagged in the vertical direction). As another pattern, the position is moved horizontally parallel to the right end of the measuring range, and when the position is reached to the right end, the position is moved vertically by a predetermined distance, and the position is moved parallel to the left end of the measuring range repeatedly (Irradiate in a zigzag direction.). As another pattern, the position to be irradiated with light is moved horizontally parallel to the left and right, and when the position is moved vertically, the position is moved diagonally to the vertical direction. As described above, various irradiation patterns exist.

In addition, a plurality of optionally installed sensors 14 (e.g., second and third LiDAR 51b, 51c and one or more cameras 52 shown in FIG. 2) as object detection devices ODD for detecting objects around the crane 1 are detachably installed on the lateral surface of the upper swivel body 3 and the lateral surface, lower surface, or upper surface of the counterweight 5. The optionally installed sensors 14 may include LiDAR 51 for widely measuring position information (Three-Dimensional information including the position and shape (attitude) of the surrounding object as well as the position information of a single point of the surrounding object) of objects around the crane 1. The LiDAR 51 irradiates the external space with laser light having a predetermined irradiation pattern different from that of the reference sensor 13, and measures position information 41 the surrounding objects. The irradiation pattern of the LiDAR 51 as the reference sensor 13 and the LiDAR 51 as the optionally installed sensor 14 may be the same.

The optionally installed sensor 14 is detachably arranged at any position of the upper swivel body 3 or the counterweight 5 of the crane 1 by a magnet, for example, and can be easily moved by hand without relying on tools. Thus, a worker can freely change the installation position even if a place where the worker wants to measure (the place where the worker wants to see) changes according to a situation of a site. A means for detachably attaching the optionally installed sensor 14 to the upper swivel body 3 or the like is not limited to the magnet. For example, an elastically deformable gripping member such as a spring member may be accommodated in a plurality of holes (attachment parts) previously installed in the counterweight 5 or the upper swivel body 3, and the attachment shaft integral with the optionally installed sensor 14 is pushed into the hole (attachment part) until a tactile sensation indicating attachment is felt (until it clicks), so that the attachment shaft of the optionally installed sensor 14 is elastically held by the gripping member in the hole (attachment part). In this case, the optionally installed sensor 14 can push the attachment shaft into the gripping member only by hand (without using tools), and the attachment shaft can be pulled out from the gripping member.

The reference sensor 13 is disposed at a position near the rear end of the main frame 11 of the upper swivel body 3 and on a centerline extending in the longitudinal direction through the swivel center of the upper swivel body 3. This sensor center axis (rotation axis) is regarded as the reference position of the reference sensor 13, and when an attitude line indicating an attitude of the reference sensor 13 is positioned along the centerline extending in the longitudinal direction through the swivel center of the upper swivel body 3, it is regarded as the reference attitude of the reference sensor 13. The position of the reference sensor 13 is a predetermined position and is recorded in a storage 212 described later. The reference sensor 13 is not limited to the position shown in FIG. 1, but can be fixed to any position as long as the fixed position is predetermined position and is recorded in the storage 212 described later.

As shown in FIG. 3, the periphery monitoring apparatus for the work machine SMA of the present embodiment includes, for example, the plurality of object detection devices ODD for detecting objects around the crane 1 as a work machine, and the calibration part 211 for calibrating the coordinate systems of the plurality of object detection devices ODD. The calibration part 211 includes, for example, a controller 21 mounted on the upper swivel body 3 of the crane 1.

Here, the plurality of object detection devices ODD includes, for example, LiDAR 51 or a camera 52 as the aforementioned reference sensor 13 or optionally installed sensor 14. The LiDAR 51 or the camera 52 as the reference sensor 13 can be used as a calibration standard of, for example, the LiDAR 51 or the camera 52 as the optionally installed sensor 14 to be calibrated. The LiDAR 51 or the camera 52 as the optionally installed sensor 14 after calibration can be used as a calibration standard of, for example, the LiDAR 51 or the camera 52 before calibration.

The periphery monitoring apparatus for the work machine SMA may include, for example, an input device 22, a sound output device 23, and a display device 24. The input device 22, the sound output device 23, and the display device 24 are installed, for example, around a driver's seat where the operator sits in the cabin 6 of the upper swivel body 3. The input device 22 includes, for example, switches, buttons, levers, pedals, touch panels, keyboards, mice, and the like. The sound output device 23 includes, for example, a buzzer, a speaker, and the like. The display device 24 includes, for example, a liquid crystal display, an organic EL display, and the like.

The controller 21 includes, for example, a central processing unit (CPU), and controls the operation of each part of the crane 1. The controller 21 includes a function of an electronic control unit (ECU), and is arranged in the upper swivel body 3. Specifically, the controller 21 operates the crane 1 based on the operation input from the operator's input device 22, develops various programs stored in advance in the storage 212, reads various data, and executes various processing using the developed programs and the read various data.

The controller 21 has, for example, functions of the calibration part 211, the storage 212, and an output part 213 achieved by executing various programs by a CPU. Each part of the controller 21 may be achieved by, for example, a common hardware or a plurality of different hardware.

The calibration part 211 sequentially executes a plurality of calibration algorithms in an ascending order of an amount of processing time or a number of manual operations until the calibration of the object detection device ODD is completed. The storage 212 stores, for example, various data and programs including a plurality of calibration algorithms in a nonvolatile storage device constituting the controller 21 or connected to the controller 21. The output part 213, for example, synthesizes and outputs the results of detection of objects by the plurality of object detection devices ODD.

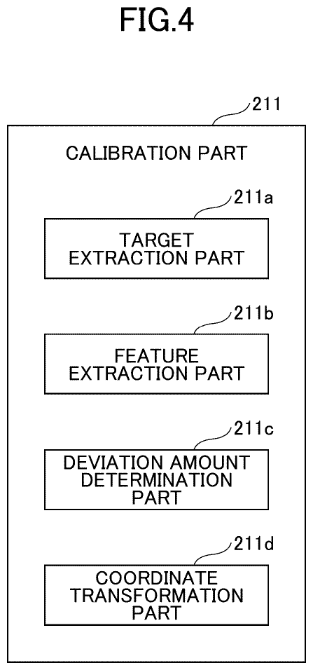

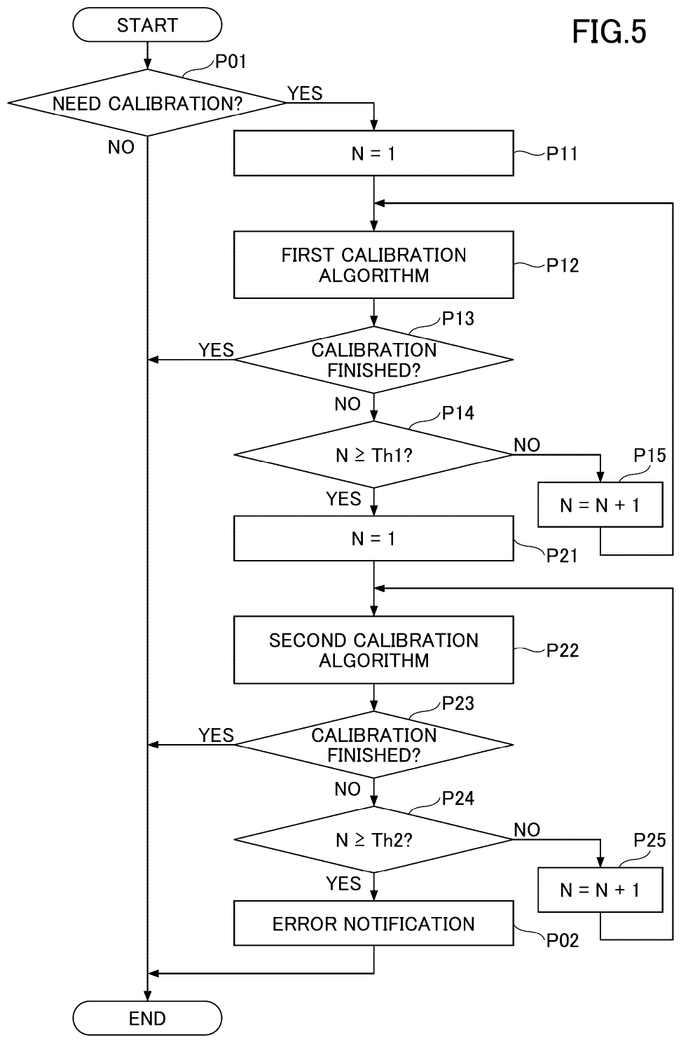

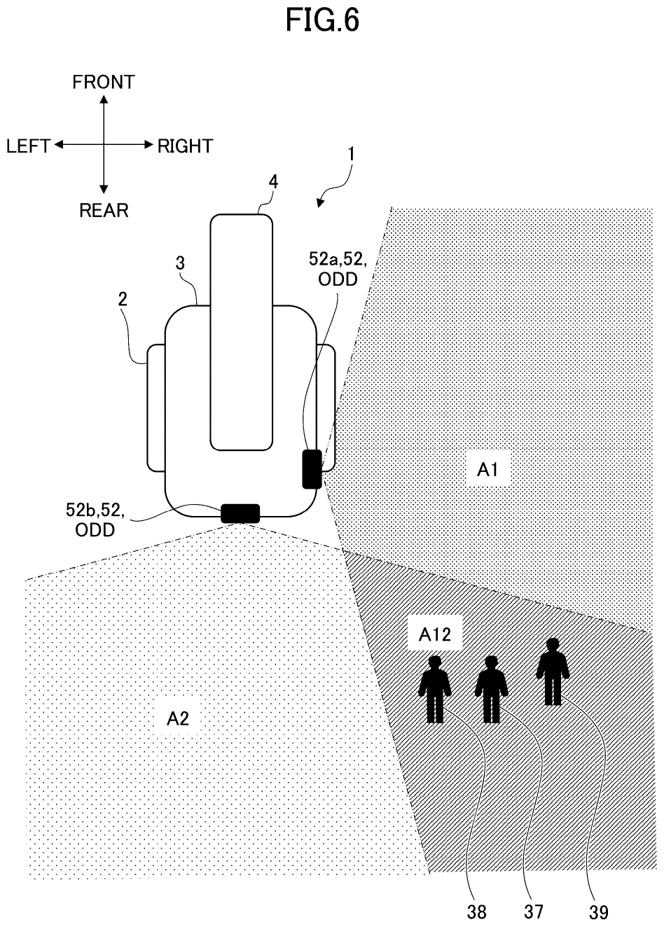

FIG. 4 is a block diagram illustrating details of a calibration part 211 shown in FIG. 3. FIG. 5 is a flow diagram illustrating an example of calibration processing by the calibration part 211 shown in FIGS. 3 and 4. FIG. 6 is a schematic plane view illustrating an example of calibration object arrangement in calibration processing shown in FIG. 5.

The calibration part 211 includes, for example, a target extraction part 211a, a feature extraction part 211b, a deviation amount determination part 211c, and a coordinate transformation part 211d, as shown in FIG. 4. Each part of the calibration part 211 represents a function achieved by, for example, executing various programs by the CPU of the controller 21.

Since the work machine includes, for example, a work attachment for moving or transporting a cargo or load, the positions and attitudes of a plurality of object detection devices ODD mounted on the work machine and detecting surrounding objects may vary. Specifically, workers such as operators and maintenance personnel of a work machine such as the crane 1 start the flow of the calibration process shown in FIG. 5, for example, after disassembly and assembly of the crane 1, or when displacement of the object detection device ODD due to vibration during operation of the crane 1 occurs. Before starting the flow of the calibration process, for example, workers place the calibration object in an overlapping detection range A12, where detection ranges of multiple object detection devices ODD intersect, as shown in FIG. 6.

Specifically, in the example shown in FIG. 6, the detection range Al of the first camera 52a as the object detection device ODD and the detection range A2 of the second camera 52b as the object detection device ODD share the overlapping detection range A12. In the overlapping detection range A12, persons such as field workers are placed as the calibration objects 37, 38, and 39. The number of people as the calibration objects 37, 38 and 39 is not particularly limited. Also, in case of calibrating two LiDARs 51 as object detection devices ODD or the LiDAR 51 and the camera 52, the calibration objects 37, 38 and 39 can be arranged in the overlapping detection range where their detection ranges intersect, as in the example shown in FIG. 6.

A worker who calibrates the coordinate systems of the plurality of object detection devices ODD places the calibration objects 37, 38 and 39 in the overlapping detection range, and then inputs a start instruction of calibration processing to the controller 21 via, for example, the input device 22. When the start instruction of calibration processing is input via, for example, the input device 22, the controller 21 starts the processing flow shown in FIG. 5, and the calibration part 211 determines whether or not calibration is necessary (process P01).

In this process P01, the calibration part 211 obtains results of detection of objects including results of detection of calibration objects 37, 38 and 39 from the plurality of object detection devices ODD having the overlapping detection range A12 as shown in FIG. 6 by, for example, the target extraction part 211a. Furthermore, the target extraction part 211a extracts results of detection of calibration objects 37, 38 and 39 arranged in the overlapping detection range A12 from the obtained results of detection of each object detection device ODD.

Thereafter, the calibration part 211 extracts feature points by, for example, the feature extraction part 211b using results of detection of objects 37, 38 and 39 by each object detection device ODD extracted by the target extraction part 211a. Further, the calibration part 211 calculates, for example, the deviation amount determination part 211c, the amount of deviation of the feature points extracted from the results of detection of the objects 37, 38, and 39 by the object detection devices ODD.

If, for example, the calculated amount of deviation is within the allowable range stored in the storage 212, the deviation amount determination part 211c determines that calibration is unnecessary (NO) in the process P01. In this case, the calibration part 211 terminates the flow of the calibration process shown in FIG. 5. If, for example, the calculated amount of deviation is outside the allowable range stored in the storage 212, the deviation amount determination part 211c determines that calibration is necessary (YES) in the process P01.

In this case, the calibration part 211 sets a repetition number N of the first calibration algorithm to one (process P11) and executes the first calibration algorithm (process P12). The first calibration algorithm requires less processing time than the second calibration algorithm described later. Conversely, the calibration accuracy of the first calibration algorithm is lower than that of the second calibration algorithm described later, for example.

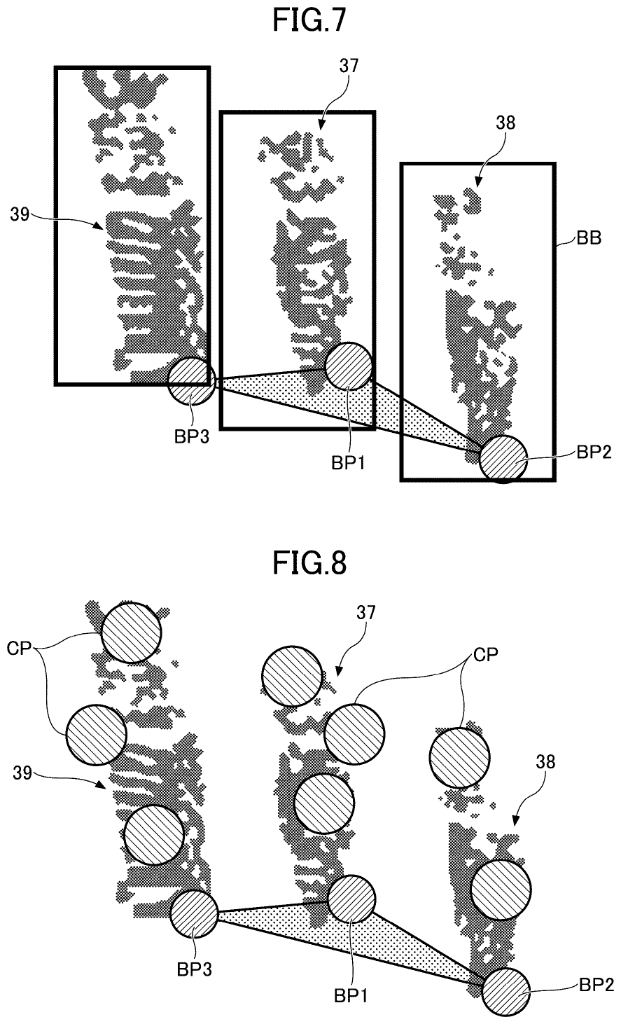

FIG. 7 is a drawing describing an example of the first calibration algorithm. In the example shown in FIG. 7, the object detection device ODD of the calibration reference and the object detection device ODD of the calibration target are both LiDAR 51. In this case, the calibration part 211 can execute the following first calibration algorithm by the target extraction part 211a, the feature extraction part 211b, the deviation amount determination part 211c, and the coordinate transformation part 211d.

The target extraction part 211a extracts results of detection of the objects 37, 38, and 39 located in the overlapping detection range from the LiDAR 51 of the calibration reference and the calibration target. Based on the results of detection of the extracted objects 37, 38, and 39, the feature extraction part 211b defines three-dimensional objects other than the ground surface as persons who are the calibration objects 37, 38 and 39, and generates a bounding box BB. Furthermore, the feature extraction part 211b extracts the foot balance points BP1, BP2, and BP3 of the objects 37, 38, and 39 as feature points by automatic calculation.

The deviation amount determination part 211c calculates the position and area of a first triangle whose vertices are the foot balance points BP1, BP2, and BP3, which are feature points extracted from the results of detection of the LiDAR 51 of the calibration reference. The deviation amount determination part 211c calculates the position and area of a second triangle whose vertices are the foot balance points BP1, BP2, and BP3, which are feature points extracted from the results of detection of the LIDAR 51 of the calibration target.

Further, the deviation amount determination part 211c calculates, for example, a ratio of an area of a portion where the first triangle and the second triangle overlap to the area of the first triangle as the amount of deviation. The coordinate transformation part 211d converts the coordinate system of the LiDAR 51 to be calibrated so as to reduce the amount of deviation by, for example, superimposing the first triangle and the second triangle. Thus, the first calibration algorithm (process P12) ends.

The calibration part 211 can use, for example, the first calibration algorithm in the process P01 for determining the necessity of calibration. That is, the deviation amount determination part 211c may determine that calibration is necessary if the amount of deviation, which is the ratio of the area of the part where the first triangle and the second triangle overlap with the area of the first triangle, is outside the predetermined tolerance range, for example, less than 90%.

After the first calibration algorithm (process P12) ends, the calibration part 211 determines whether the calibration is complete (process P13). In this process P13, the calibration part 211 executes the same process as the process P01 for determining the necessity of calibration using the object result of detection by the LiDAR 51 after calibration. If the amount of deviation calculated by the deviation amount determination part 211c is within the allowable range, it is determined that calibration has been completed (YES), and the flow of the calibration process shown in FIG. 5 ends.

Conversely, in process P13, if the amount of deviation calculated by the feature extraction part 211b is outside the allowable range, the calibration part 211 determines that calibration has not been completed (NO), and determines whether the repetition number N of the first algorithm is equal to or greater than the threshold Th1 (process P14). Here, the threshold Th1 is set to a configurable number of times, for example, 3 times, and stored in the storage 212 in advance.

In process P14, if the calibration part 211 determines that the repetition number N of the first calibration algorithm is less than the threshold Th1 (NO), it adds one to the repetition number N of the first calibration algorithm (process P15), and executes the first calibration algorithm again (process P12). Then, in process P13, it is determined that the repetition calibration has not been completed (NO), and the addition of the repetition number N (process P15) and the execution of the first calibration algorithm (process P12) are repeated, so that the repetition number N reaches the threshold Th1.

In this case, in process P14, the calibration part 211 determines that the repetition number N of the first calibration algorithm is equal to or greater than the threshold Th1 (YES), and sets the repetition number N of the second calibration algorithm to 1 (process P21). Here, the calibration part 211 may notify a worker who calibrates a plurality of object detection devices ODD via the sound output device 23 and the display device 24, for example, that the repetition number N of the first calibration algorithm has reached the threshold Th1 and that the second calibration algorithm is executed.

Thereafter, the calibration part 211 executes the second calibration algorithm (process P22). This second calibration algorithm requires more processing time (longer processing time) than the first calibration algorithm. Conversely, this second calibration algorithm has, for example, higher calibration accuracy than the first calibration algorithm.

FIG. 8 is a drawing describing an example of the second calibration algorithm. In the example shown in FIG. 8, the object detection device ODD of the calibration reference and the object detection device ODD of the calibration target are both LiDAR 51. In this case, the calibration part 211 can execute, for example, the second calibration algorithm using a known ICP (Iterative Closest Point).

Thus, the calibration part 211 automatically estimates a plurality of feature points CP of the objects 37, 38, and 39 based on the result of detection of the object detection device ODD of the calibration reference, a plurality of feature points CP of the objects 37, 38, and 39 based on the result of detection of the object detection device ODD of the calibration target, and corresponding points of each feature point CP. Further, based on the estimation result, the calibration part 211 converts, for example, the coordinate system of the LiDAR 51 to be calibrated. Thus, the second calibration algorithm (process P22) ends.

In this second calibration algorithm, the processing time tends to increase, for example, when the number of objects included in the result of detection of the object detection device ODD increases. Note that even in the second calibration algorithm, the amount of deviation between the results of detection of the object detection devices ODD may be calculated by calculating the areas of the foot balance points BP1, BP2, and BP3 of the objects 37, 38, and 39 and the triangles having them as vertices.

After the second calibration algorithm (process P22) ends, the calibration part 211 determines whether the calibration is complete (process P23). In this process P23, the calibration part 211 uses the result of detection of the object by the LiDAR 51 after the calibration to execute the same process as in the process P01 for determining whether the calibration is necessary. Then, if the amount of deviation calculated the by deviation amount determination part 211c is within the allowable range, it determines that the calibration is complete (YES), and ends the flow of the calibration process shown in FIG. 5.

Conversely, in the process P23, if the amount of deviation calculated by the deviation amount determination part 211c is outside the allowable range, it is determined that calibration has not been completed (NO), and it is determined whether the repetition number N of the second algorithm is equal to or greater than the threshold Th2 (process P24). Here, the threshold Th2 is set to a configurable number of times, for example, three times, and stored in the storage 212 in advance.

In the process P24, when the calibration part 211 determines that the repetition number N of the second calibration algorithm is less than the threshold Th2 (NO), it adds 1 to the repetition number N of the second calibration algorithm (process P25), and executes the second calibration algorithm (process P22) again. Then, in the process P33, it is determined that the repetition calibration has not been completed (NO), and the addition of the repetition number N (process P25) and the execution of the second calibration algorithm (process P22) are repeated, so that the repetition number N reaches the threshold Th2.

In this case, in the process P24, the calibration part 211 determines that the repetition number N of the second calibration algorithm is not less than the threshold Th2 (YES). Furthermore, the calibration part 211 executes an error notification (process P02) to notify the worker who calibrates the plurality of object detection devices ODD via, for example, the sound output device 23 and the display device 24 that the repetition number N of the second calibration algorithm has reached the threshold Th2 and the calibration has ended. Thereafter, the calibration part 211 terminates the flow of the calibration process shown in FIG. 5.

In the example shown in FIG. 5, the first calibration algorithm and the second calibration algorithm are sequentially executed as the plurality of calibration algorithms, but a third calibration algorithm may be executed or a fourth calibration algorithm may be executed after the end of the process P24, as in the process P21 to the process P25. That is, the number of the plurality of calibration algorithms that the calibration part 211 sequentially executes in the calibration process is configurable.

As described above, the periphery monitoring apparatus for the work machine SMA of the present embodiment includes the plurality of object detection devices ODD for detecting objects around the crane 1, which is the work machine, and the calibration part 211 for calibrating coordinate systems of the object detection devices ODD. The calibration part 211 sequentially executes a plurality of calibration algorithms for the calibration of the object detection devices ODD in an ascending order of an amount of processing time or a number of manual operations until the calibration of the object detection devices ODD is completed.

According to the periphery monitoring apparatus for the work machine SMA of the present embodiment, when the calibration of the object detection device ODD is completed, the calibration algorithm which finishes processing in a shorter time can be preferentially executed. Therefore, when the calibration of the object detection device ODD is completed by the first calibration algorithm, the time required for calibration of the object detection device ODD can be shortened.

Moreover, when the object detection device ODD cannot be configured by the first calibration algorithm, the calibration accuracy of the object detection device ODD can be further improved by sequentially executing the calibration algorithm which requires more processing time. Therefore, according to the periphery monitoring apparatus for the work machine SMA of the present embodiment, efficiency in performing calibration of the plurality of object detection devices ODD can be improved, and productivity can be improved while ensuring safety of the work machine such as the crane 1.

Further, in the periphery monitoring apparatus for the work machine SMA of the present embodiment, the calibration part 211 calculates an amount of deviation between results of detection of the plurality of object detection devices ODD based on results of detection of a same object 37, 38, and 39 by the plurality of object detection devices ODD, and determine necessity or completion of the calibration based on the amount of deviation.

With this configuration, the periphery monitoring apparatus for the work machine SMA of the present embodiment can determine the necessity or completion of calibration based on the results of detection of the same object 37, 38, and 39 by the plurality of object detection devices ODD.

Further, in the periphery monitoring apparatus for the work machine SMA of the present embodiment, the calibration part 211 executes the second calibration algorithm which is a next algorithm among the plurality of calibration algorithms when the calibration does not complete after repeating the first calibration algorithm, which is an ongoing calibration algorithm, among the plurality of calibration algorithms, a predetermined number of times.

With this configuration, even if the calibration is not completed by the first calibration algorithm which requires the least processing time or manual operation, the periphery monitoring apparatus for the work machine SMA of the present embodiment can complete the calibration by the first calibration algorithm executed in the second and subsequent times. Thus, when the calibration is not completed by the first calibration algorithm, the processing time or manual operation can be reduced than when the second calibration algorithm which requires more processing time or manual operation than the first calibration algorithm is immediately executed when the calibration is not completed by the first calibration algorithm.

In the periphery monitoring apparatus for the work machine SMA of the present embodiment, the plurality of calibration algorithms executed by the calibration part 211 includes the first calibration algorithm. The first calibration algorithm performs coordinate transformations by which polygons align between at least two of the plurality of object detection devices, each of the polygons having vertices that are points on the ground surface, which are obtained by projecting foot balance points BP1, BP2, and BP3 of three or more same objects 37, 38, and 39 detected by each of the plurality of object detection devices ODD.

With this configuration, the periphery monitoring apparatus for the work machine SMA of the embodiment can automatically perform present calibration processing of the plurality of object detection devices ODD in a short time compared with a method such as ICP. As a result, the efficiency of calibration processing when performing calibration of the plurality of object detection devices ODD can be improved and labor of workers can be reduced.

Further, as shown in FIG. 3, the periphery monitoring apparatus for the work machine SMA of the present embodiment has a sound output device 23 and a display device 24 as output parts for synthesizing and outputting the results of detection of the object by the plurality of object detection devices.

With this configuration, the periphery monitoring apparatus for the work machine SMA of the present embodiment can detect objects around the work machine such as the crane 1 by the plurality of object detection devices ODD after calibration. Furthermore, the results of detection of the plurality of object detection devices ODD can be synthesized to provide information on surrounding objects to the operator of the work machine such as the crane 1 by using output devices such as the sound output device 23 and the display device 24. Therefore, the periphery monitoring apparatus for the work machine SMA of the present embodiment can ensure the safety of the work machine such as the crane 1.

As described above, according to the present embodiment, it is possible to provide the periphery monitoring apparatus for the work machine SMA which can improve the efficiency of calibration of the plurality of object detection devices ODD and improve productivity while ensuring the safety of the work machine.

### EMBODIMENT 2

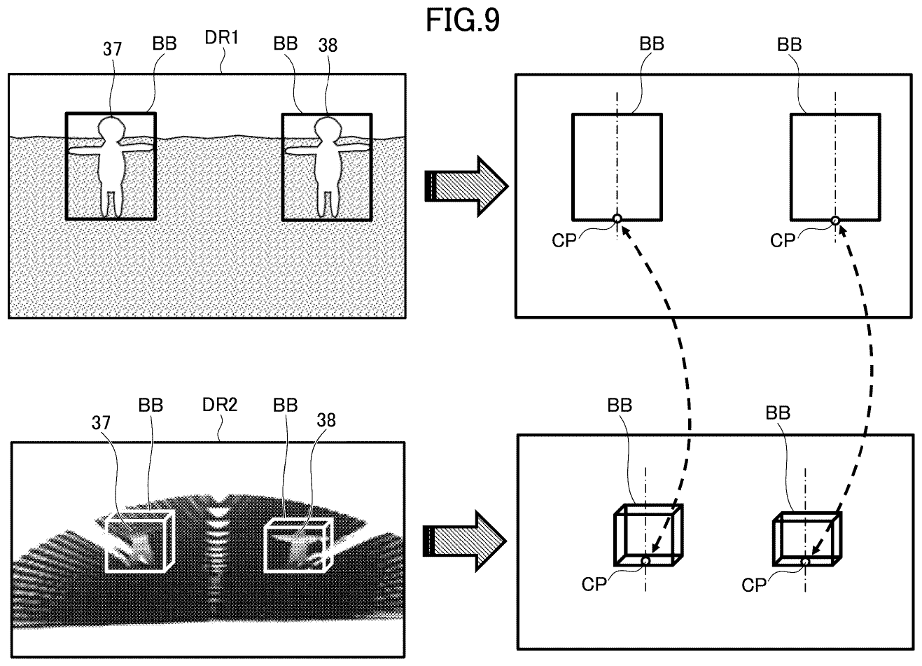

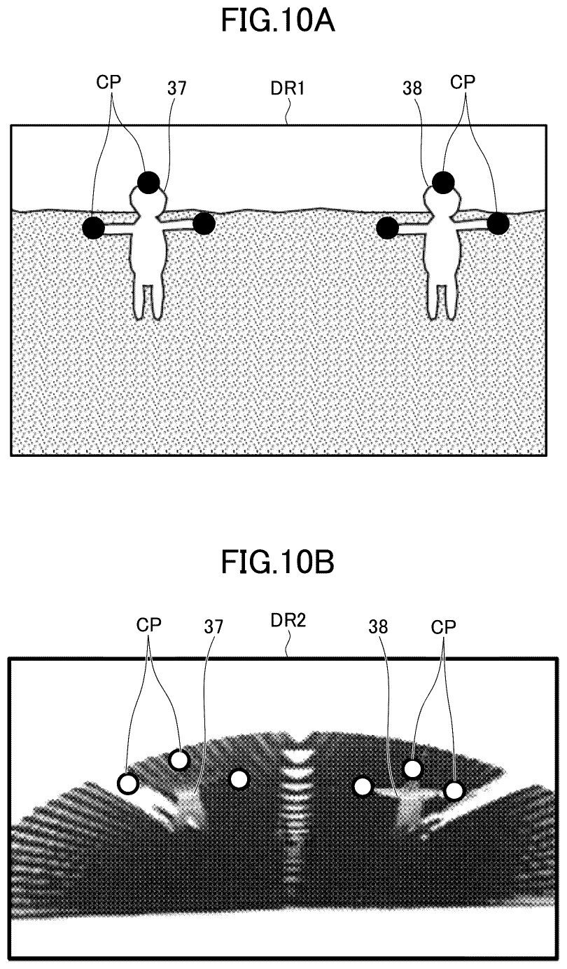

Next, Embodiment 2 of the periphery monitoring apparatus for the work machine according to this disclosure will be described with reference to FIGS. 9, 10A, and 10B. FIG. 9 is a drawing describing an example of the first calibration algorithm shown in FIG. 5. FIGS. 10A and 10B are drawings describing an example of the second calibration algorithm shown in FIG. 5.

In the periphery monitoring apparatus for the work machine SMA of Embodiment 1, the object detection device ODD of the calibration reference and the object detection device ODD of the calibration target are both LiDAR 51. However, in the periphery monitoring apparatus for the work machine SMA of the present embodiment, the object detection device ODD of the calibration reference and the object detection device ODD of the calibration target are camera 52 and LiDAR 51.

The periphery monitoring apparatus for the work machine SMA of the present embodiment differs from the periphery monitoring apparatus SMA of Embodiment 1 in the contents of the first calibration algorithm (process P12) and the second calibration algorithm (process P22) shown in FIG. 5. Since other configurations of the periphery monitoring apparatus for the work machine SMA of the present embodiment are the same as those of the periphery monitoring apparatus SMA of Embodiment 1, similar parts are denoted by the same reference numerals and description is omitted.

The periphery monitoring apparatus for the work machine SMA of the present embodiment executes the first calibration algorithm shown in FIG. 5 by the calibration part 211, for example, in the same manner as the periphery monitoring apparatus of SMA Embodiment 1 (process P12). In this process P12, the calibration part 211 obtains results of detection of objects including results of detection of calibration objects 37 and 38 arranged in the overlapping detection range from the camera 52 and LiDAR 51 having the overlapping detection range, for example, by the target extraction part 211a.

Furthermore, the target extraction part 211a extracts results of detection of calibration objects 37 and 38 arranged in the overlapping detection range from the obtained results of detection of the camera 52 and LiDAR 51. Specifically, as shown in the upper left of FIG. 9, for example, the target extraction part 211a recognizes the objects 37 and 38 from the result of detection DR1 of the camera 52 and generates bounding boxes BB surrounding the objects 37 and 38. Also, as shown in the lower left of FIG. 9, for example, the target extraction part 211a generates bounding boxes BB surrounding three-dimensional objects that remain after the result of detection of other objects including the ground surface is removed from the result of detection DR2 of the LiDAR 51.

Next, as shown in the upper right of FIG. 9, for example, the feature extraction part 211b extracts the coordinates of the lower end center of a rectangular bounding box BB generated based on the result of detection DR1 of the camera 52 as the feature point CP. Similarly, as shown in the lower right of FIG. 9, for example, the feature extraction part 211b extracts the coordinates of the lower end center of the rectangular bounding box BB generated from the result of detection of the LiDAR 51 as the feature point CP.

Thereafter, the deviation amount determination part 211c calculates the amount of deviation based on the coordinates of the feature point CP extracted based on the result of detection DR1 of the camera 52 and the coordinates of the feature point CP extracted based on the result of detection of the LiDAR 51. Furthermore, the coordinate transformation part 211d converts the coordinates of the object detection device ODD to be calibrated out of the LiDAR 51 and the camera 52 so as to reduce the calculated amount of deviation and align the coordinates of the feature point CP.

This first calibration algorithm requires less processing time than a method such as ICP, for example, but the calibration accuracy is slightly inferior because it cannot accurately measure the size, shape, and position of a person as the objects 37 and 38 for calibration. The calibration accuracy can be improved by repeatedly executing the first calibration algorithm while changing the arrangement of the calibration objects 37 and 38. Further, the calibration part 211 may perform processes P01 for determining the necessity of calibration and processes P13 and P23 for determining the completion of calibration based on the amount of deviation calculated as described above.

The periphery monitoring apparatus for the work machine SMA of the present embodiment executes the second calibration algorithm shown in FIG. 5 by the calibration part 211, for example, in the same manner as the periphery monitoring apparatus for the work machine SMA of Embodiment 1 (process P22). In this process P22, the calibration part 211 obtains the result of detection DR1 of the camera 52 as shown in FIG. 10A, and the result of detection DR2 of the result of detection DR2 of the LiDAR 51 by the target extraction part 211a as shown in FIG. 10B, for example, and extracts the objects 37 and 38, respectively.

Furthermore, the feature extraction part 211b displays the objects 37 and 38 extracted based on the result of detection DR1 of the camera 52 and the objects 37 and 38 extracted based on the result of detection DR2 of the LiDAR 51 on the display device 24, for example, as shown in FIGS. 10A and 10B. Furthermore, the feature extraction part 211b receives the input of the feature point CP by a worker who configures the camera 52 and the LiDAR 51 via an input device 22 such as a mouse, for example.

Specifically, the worker operates the input device 22 such as a mouse while viewing the images of the objects 37 and 38 displayed on the display device 24. Then, the worker manually selects the corresponding feature points CP for both the objects 37 and 38 extracted based on the result of detection DR1 of the camera 52 and the objects 37 and 38 extracted based on the result of detection DR2 of the LIDAR 51, and manually inputs them to the feature extraction part 211b.

Then, the deviation amount determination part 211c calculates the amount of deviation between the result of detection of the camera 52 and the result of detection of the LiDAR 51 based on the corresponding feature points CP. Then, the coordinate transformation part 211d converts the coordinates of the object detection device ODD to be calibrated among the camera 52 and the LiDAR 51 so as to reduce the amount of deviation and align the corresponding feature points CP.

As described above, in the periphery monitoring apparatus for the work machine SMA of the present embodiment, the plurality of calibration algorithms executed by the calibration part 211 includes the second calibration algorithm for performing coordinate transformations by manually associating the feature points CP of the same object 37 and 38 detected by each of the plurality of object detection devices ODD.

According to the second calibration algorithm of the present embodiment, by manually operating the mouse as the input device 22 and selecting the feature points CP on the image displayed on the display device 24, the corresponding feature points CP can be specified relatively accurately. Conversely, this second calibration algorithm requires more processing time (longer processing time) than the first calibration algorithm described above, and the burden of manual operation by the operator is large.

However, the periphery monitoring apparatus for the work machine SMA according to the present embodiment includes the plurality of object detection devices ODD for detecting objects around the work machine such as the crane 1, and the calibration part 211 for calibrating the coordinate systems of the plurality of object detection devices ODD, as in the case of Embodiment 1. The calibration part 211 sequentially executes the plurality of calibration algorithms for the calibration in an ascending order of an amount of processing time or a number of manual operations until the calibration of the object detection device ODD is completed.

Therefore, according to the periphery monitoring apparatus for the work machine SMA according to the present embodiment, as in the case of Embodiment 1, the efficiency of calibration of the plurality of object detection devices ODD can be improved, and the productivity can be improved while ensuring the safety of the work machine such as the crane 1.

Further, in the periphery monitoring apparatus for the work machine SMA according to the present embodiment, the plurality of calibration algorithms executed by the calibration part 211 include a calibration algorithm for performing coordinate transformations by which lower end central points of bounding boxes BB align between at least two of the plurality of object detection devices ODD, each of the bounding boxes BB surrounding the same object 37, 38 detected by each of the plurality of object detection devices ODD.

With such configurations, according to the periphery monitoring apparatus for the work machine SMA according to the present embodiment, the calibration algorithm can be automatically executed by the calibration part 211, and the burden on the worker performing the calibration can be reduced. Moreover, by executing the calibration algorithm described above by the calibration part 211, the processing time of the calibration process can be shortened compared with a technique such as ICP.

In the periphery monitoring apparatus for the work machine SMA of Embodiment 1 and Embodiment 2, as shown in FIG. 5, the calibration part 211 first executes the process P01 for determining the necessity of calibration, but this process P01 can be omitted.

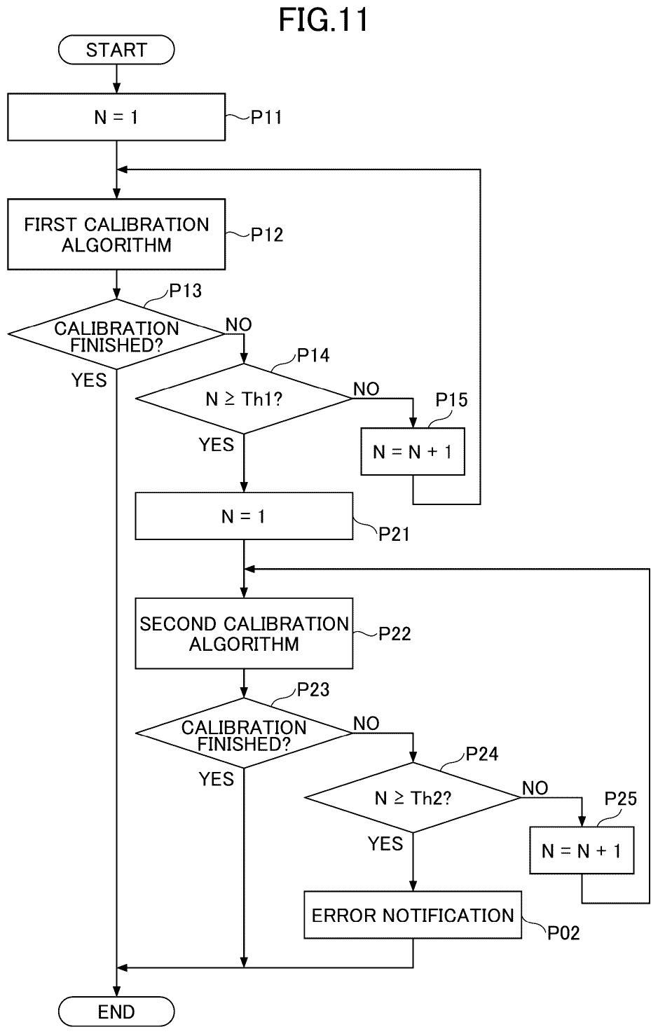

FIG. 11 is a flow diagram showing a modified example of the calibration process of FIG. 5. In the example shown in FIG. 11, the calibration part 211 sets the repetition number N of the first calibration algorithm to 1 without executing the process P01 for determining the necessity of calibration first (process P11). Then, similarly to the process flow shown in FIG. 5, the first calibration algorithm (process P12) and the second calibration algorithm (process P22) are sequentially executed until the calibration of the object detection device ODD is completed.

The process P01 for determining the necessity of calibration performs processing up to calculation of the amount of deviation in the same manner as the first calibration algorithm except for coordinate transformations. Therefore, in the example shown in FIG. 11, the calculation of the amount of deviation is effectively utilized to execute the first calibration algorithm by performing coordinate transformations based on the amount of deviation. Thus, when calibration of the object detection device ODD is required, the process P01 for determining the necessity of calibration is omitted and the efficiency of the calibration process can be improved.

The preferred embodiments of the present invention have been described in detail above. However, the present invention is not limited to the above-described embodiments. Various variations and modifications may be applied to the above-described embodiments without departing from the scope of the present invention. Moreover, the features described separately can be combined as long as there is no technical conflict.

For example, in the above-described embodiment, the LiDAR and the camera have been described as object detection devices, but the object detection device may include other sensors capable of detecting objects around the work machine.

Moreover, as a calibration object to which the first calibration algorithm similar to Embodiment 2 is applied, and which is arranged in the overlapping detection range of the plurality of object detection devices may be used in the second calibration algorithm. Thus, by using the calibration board as the calibration object, feature points such as a center of a cross pattern and corners of a board can be clearly defined. Therefore, even when feature points are automatically extracted by image processing, the measurement tolerance can be reduced.

In the calibration algorithm for automatically performing calibration, calibration may be difficult if many objects similar to the calibration object exist around the work machine. In this case, the calibration part may preferentially execute the second calibration algorithm by manual operation described in Embodiment 2 by user setting, for example.

In addition, the calibration part may refer to, for example, the absolute value of the amount of deviation calculated by the deviation amount determination part and the improvement history of deviation, select an appropriate calibration algorithm from among the plurality of calibration algorithms based on the absolute value of the amount of deviation and the improvement history information, and sequentially execute the calibration algorithms.

What is claimed is:

1. A periphery monitoring apparatus for a work machine, comprising:
a plurality of object detection devices configured to detect an object around the work machine; and
a calibration part configured to perform calibration of coordinate systems of the plurality of object detection devices,
wherein the calibration part is configured to sequentially execute a plurality of calibration algorithms for the calibration in ascending order of processing time duration and number of manual operations, until the calibration is completed.

2. The periphery monitoring apparatus for the work machine according to claim 1, wherein the calibration part is configured to calculate an amount of deviation between results of detection by the plurality of object detection devices based on results of detection of a same object by the plurality of object detection devices, and determine, based on the amount of deviation, whether the calibration is necessary, or whether the calibration is completed.

3. The periphery monitoring apparatus for the work machine according to claim 1, wherein the calibration part is configured to execute a next calibration algorithm among the plurality of calibration algorithms when the calibration does not complete after repeating an ongoing calibration algorithm, among the plurality of calibration algorithms, a predetermined number of times.

4. The periphery monitoring apparatus for the work machine according to claim 1, wherein the plurality of calibration algorithms include a calibration algorithm for performing coordinate transformations by manually associating feature points of a same object detected by each of the plurality of object detection devices.

5. The perimeter monitoring apparatus for the work machine according to claim 1, wherein the plurality of calibration algorithms include a calibration algorithm for performing coordinate transformations by which polygons align between at least two of the plurality of object detection devices, each of the polygons having vertices that are points on a ground surface obtained by projecting a balance point of three or more same objects detected by each of the plurality of object detection devices.

6. The perimeter monitoring apparatus for the work machine according to claim 1, wherein the plurality of calibration algorithms a include calibration algorithm for performing coordinate transformations by which lower end central points of bounding boxes align between at least two of the plurality of object detection devices, each of the bounding boxes surrounding a same object detected by each of the plurality of object detection devices.

7. The periphery monitoring apparatus for the work machine according to claim 1, comprising an output part configured to synthesize and output results of detection of the object by the plurality of object detection devices.
